(19) United States
(12) Patent Application Publication
(10) Pub. No.: US 2021/0303003 A1
(43) Pub. Date: Sep. 30, 2021

(54) System and method for light-based guidance of autonomous vehicles

(71) Applicant: Edgar Emilio Morales Delgado, San Francisco, CA (US)

(72) Inventor: Edgar Emilio Morales Delgado, San Francisco, CA (US)

(21) Appl. No.: 16/833,430

(22) Filed: Mar. 27, 2020

(51) Int. Cl. G05D 1/08; G05D 1/00; G05D 1/10; G05D 1/04; B64C 39/02

(52) U.S. Cl. CPC G05D 1/0808; G05D 1/0088; G05D 1/101; G05D 1/0206; B64C 39/024; B64C 2201/141; G05D 1/042

(57) ABSTRACT

A method for providing guidance to autonomous vehicles comprising emitting light signals from a plurality of light sources, wherein each light source emits a light signal with an angular dependent intensity profile, detecting the plurality of emitted light signals with an on-board light detector, processing the plurality of light signals detected by the light detector to distinguish each one of the detected light signals, comparing the distinguished detected light signals, using the distinguished detected light signals to encounter the orientation of the on-board light detector relative to the light sources, generating a control signal from the distinguished detected light signal and using the control signal to provide navigation guidance to the autonomous vehicle.

### BACKGROUND

The present invention relates to methods and systems for providing navigation guidance to autonomous vehicles. In particular, the present invention is related, but not restricted, to light-based guidance of autonomous vehicles, light-based guidance of unmanned areal vehicles and optical guidance systems.

Conventional navigation and guidance of autonomous vehicles such as ground vehicles or unmanned aerial vehicles (UAVs) use satellite positioning systems like the global positioning system (GPS) in conjunction with on-board inertial measurement units (IMUs) to calculate the absolute position and orientation of unmanned vehicles on earth or the position and orientation of unmanned vehicles relative to objects, to other vehicles or to mobile and ground stations. This conjunction is very effective in cruising maneuvers in a three-dimensional environment where the unmanned vehicles are widely spaced and far from any obstacle. However, in the case of maneuvers involving close proximity between autonomous vehicles, proximity to other objects or in aircraft maneuvers such as approaching, take-off and landing, the accuracy of satellite positioning systems is not enough to provide effective, accurate and safe motion of UAVs.

In the case of satellite-based navigation systems (for example, U.S. Pat. No. 3,789,409A), there is a theoretical limit to the position accuracy (4 meters RMS lateral accuracy for GPS under direct line of sight), which in some cases is not enough to navigate safely an UAV towards a mobile, ground station or for entering a warehouse. Moreover, since satellite navigation systems are based on measuring the different time of arrival of the radio waves emitted from the satellites, the position accuracy decreases dramatically in the presence of obstacles that produce multi-path reflection of such radio waves, resulting in significant position and orientation errors that restricts navigation of the autonomous vehicle. This is very common in urban environments, such as cities, or near high rise buildings. Furthermore, satellite-based navigation becomes impossible in situations without direct line of sight towards GPS satellites, in planets without GPS satellite infrastructure or in GPS denied environments such as the interior of a warehouse, inside building, in tunnels or underwater.

An alternative approach for guiding vehicles in GPS denied environments is based on the use of IMUs (for example, see U.S. Pat. No. 6,697,736B2), which can measure 3-axis acceleration, 3-axis angular rate of rotation and 3-axis magnetic field orientation. However, they operate with a finite sampling rate, which produces linear accumulation of acceleration errors over time, resulting in a quadratic and cubic error in velocity and position, respectively. Additionally, they are very sensitive to electromagnetic and magnetic interference, producing significant errors when used near power-lines or near objects with magnets or ferromagnetic materials and require frequent adjustment using a satellite navigation system, which is not accessible in indoors environments.

In the case of aircraft guidance in take-off and landing maneuvers, instrument landing systems have been widely used in the last decade (for example, U.S. Pat. No. 3,115,634A). They are based on arrays of antennas that produce radio-frequency waves of certain frequency and phase, generating signals that can be interpreted by the on-aircraft receiver as a glide path, providing lateral positioning and approach angle to the pilot. However, these systems require a very bulky, expensive, and power consuming infrastructure, restricting their usage to airports and guidance of large aircrafts. Furthermore, the on-board receiver is heavy, bulky, and require relatively large antennas, restricting their integration in small UAVs.

Recently, optical markers such as QR codes have been proposed as part of UAVs landing systems (such as Us. Pat. US20160122038A1). However, their implementation require high resolution on-board cameras and complex images processing algorithms which operate with a high power consumption. Another disadvantage is that such visual markers cannot be seen in fog, heavy rain, low light conditions or at large distances due to the finite camera resolution. Additionally, they are not secure and cannot be cryptographically authenticated. A malicious individual can replicate an optical marker and land UAVs outside the originally intended destination.

Consequently, there is a need for a guidance system for ground, maritime or aerial autonomous vehicles that can enable precise maneuvers such as cruise, approach, takeoff and landing in GPS denied environments or in places with intermittent access to satellite-based navigation. Moreover, there is a need for a system that can guide simultaneously a large number of unmanned vehicles in close proximity one from another, in a precise and safe manner. Additionally, there is a need for a compact guidance system for autonomous vehicles that consumes low power and can be mounted in small autonomous vehicles such as UAVs.

### SUMMARY OF THE INVENTION

The invention disclosed herein includes a system and a method for precision guidance of multiple autonomous vehicles in a safe and collision-free manner. The invention comprises a plurality of light sources emitting light signals with an angular dependent intensity profile, detecting the emitted light signals with an on-board light detector, processing the light signals and using the processed light signals to find the orientation of the autonomous vehicle relative to the light sources. In fact, in the case of UAVs, the emitted light signals can define light paths in space that serve as virtual runways or airways that can be followed precisely by the autonomous vehicles in maneuvers such as cruising, parking, approaching, takeoff and landing.

In contrast to the existing guidance methods described in the section “BACKGROUND”, the invention disclosed herein enables centimeter precise guidance of multiple autonomous vehicles in places with intermittent access or without access to satellite-based navigation, in the presence of rain or fog and in good or poor illumination conditions. Furthermore, the present invention has a low power consumption and utilizes a simple, inexpensive and compact light-emitting infrastructure. Additionally, the required on-board light detection and processing logic is compact and light weight, making it suitable for all kinds of autonomous vehicles. Moreover, the emitted light signals can transmit information, which enables cryptographic authentication of the ground stations and the autonomous vehicles, making this system secure against malicious attempts to take control over the autonomous vehicles. Precision guidance of autonomous vehicles such as UAVs enables new forms of transportation and delivery of goods, such as in-roof delivery and in-balcony delivery in a quick, efficient and safe manner.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates an example radiation pattern in a polar plot of a light source that emits light signals with an angular dependent intensity profile.

FIG. 1B illustrates the radiation patterns in a polar plot of a pair of contiguous light sources, their radiation patterns define a straight plane of equal light signal intensity.

FIG. 10 illustrates two pairs of light sources defining a straight line in space of equal light signal intensity that can be used to guide an autonomous vehicle.

FIGS. 2A-2F illustrate examples of an unmanned aerial vehicles located at different lateral positions with respect to the light sources and the respective detected light signals that the on-board light detector receives in each case.

FIGS. 3A-3F illustrate examples of an unmanned aerial vehicles located at different vertical positions with respect to the light sources and the respective detected light signals that the on-board light detector receives in each case.

FIG. 4. Illustrates an example of a plurality of pair of light sources, each pair providing guidance to an autonomous vehicle.

FIG. 5A-5B illustrates examples of on-board light sources guiding other autonomous vehicles in an ordered formation.

FIG. 6 Describes the steps to guide autonomous vehicles using light sources in accordance to the method presented in this disclosure.

### DETAILED DESCRIPTION

Embodiments of systems, devices and methods for light-based guidance of autonomous vehicles are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-know structures, materials or operations are not shown or describe in detail to avoid obscuring certain aspects.

The content of this disclosure may be applied to multiple fields, such as navigation, autonomous vehicles, aerial vehicles, marine navigation, aerospace navigation, spacecrafts docking, and satellites.

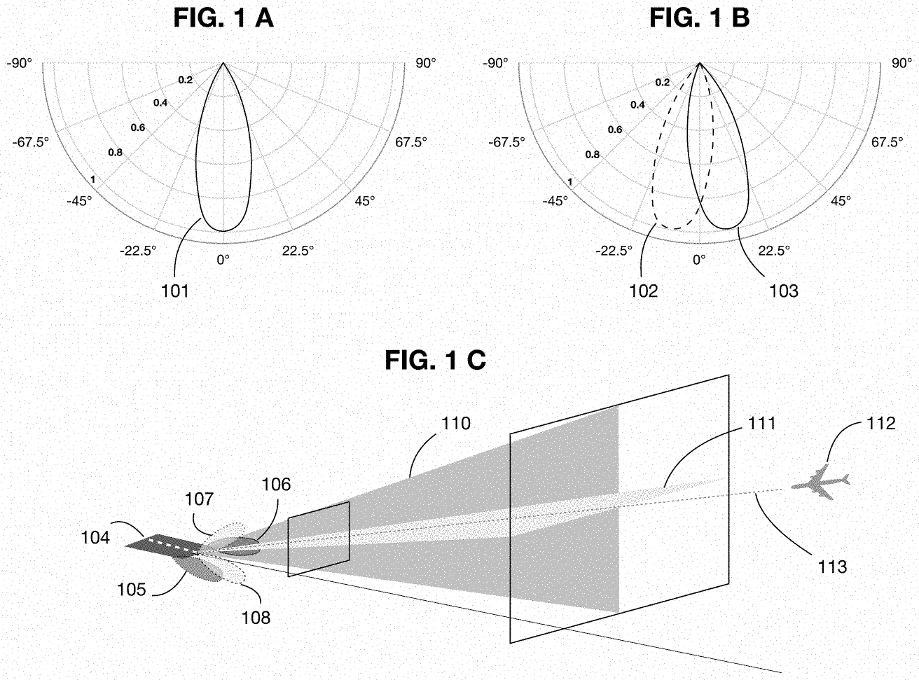

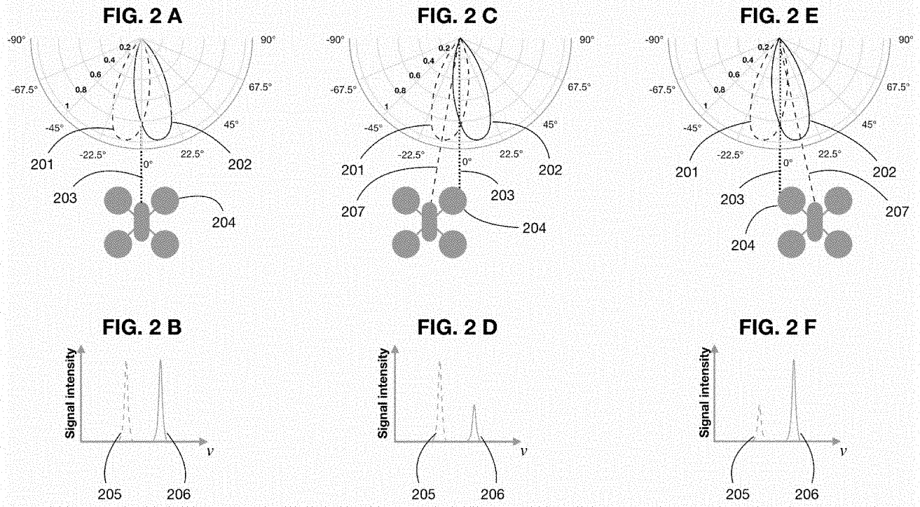

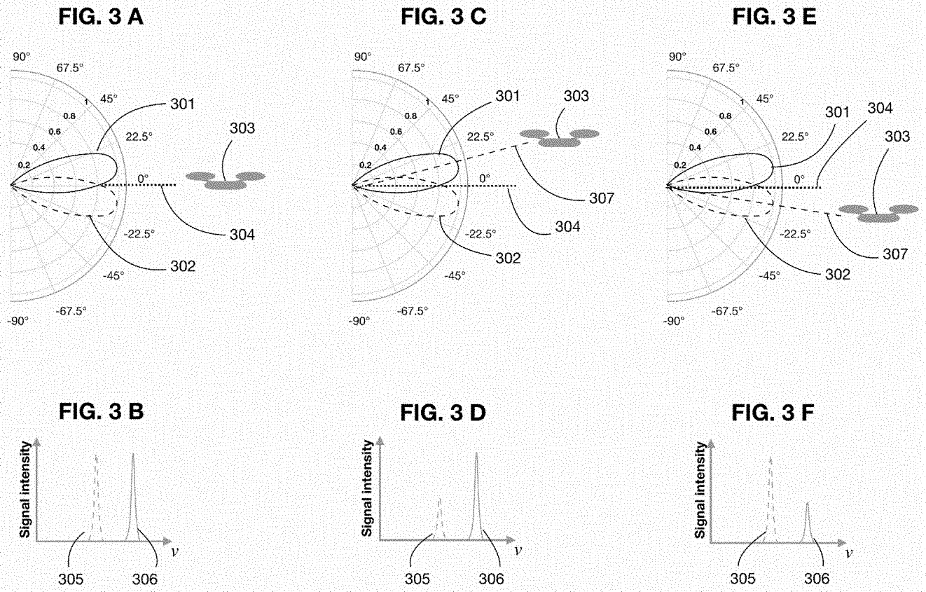

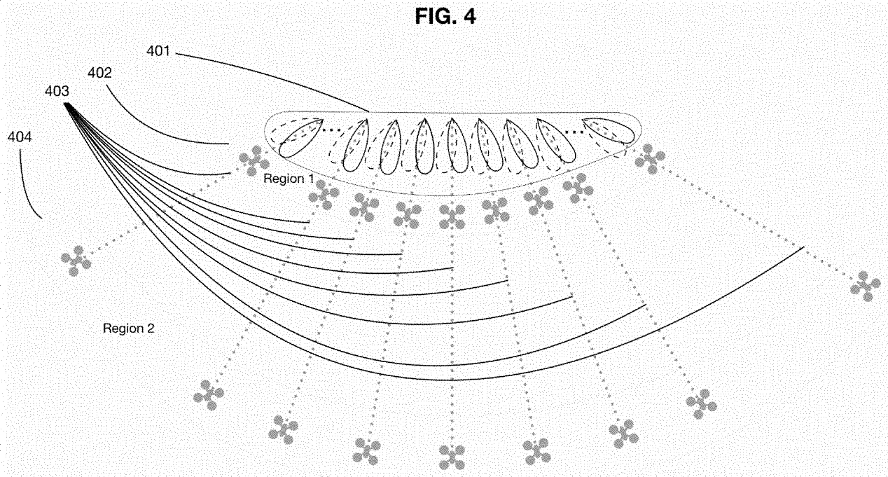

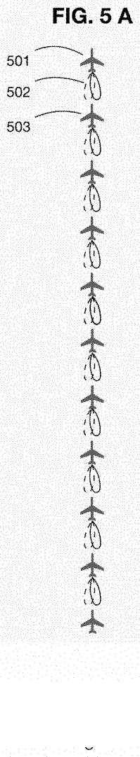

Reference throughout this specification to “one embodiment”, “an embodiment”, or “some embodiments” means that a particular feature, structure, or characteristic described may be included in at least one embodiment of the present invention, and each of these embodiments may be combined with other embodiments in accordance with the present disclosure. Thus, the appearances of the phrases “in one embodiment”, “in an embodiment”, or “in some embodiments” throughout this specification do not necessarily all refer to the same embodiment. Furthermore, the particular features, structures, or characteristics may be combined in any suitable manner in one or more embodiments. These embodiments and others will be described in more detail with references to FIGS. 1-6.

Throughout this specification, several terms of art are used. These terms are to take on their ordinary meaning in the art from which they come, unless specifically defined herein or the context of their use would clearly suggest otherwise. Also, like characters generally refer to like elements unless indicated otherwise.

Embodiments of this disclosure utilize light sources that emit light signals with an angular dependent intensity profile. An exemplary radiation pattern of a light source that emits light signals with an angular dependent intensity profile is illustrated in the polar plot shown in FIG. 1A. The angular intensity distribution 101 of the emitted light signals generates a region in space where the intensity of the light signal detected by a light detector mounted on-board in the autonomous vehicle depends on the relative position of the light detector or the vehicle with respect to the light source. In one embodiment, a pair of spaced light sources, each emitting an angular dependent intensity profile with radiation patterns 102 and 103 shown in FIG. 1B, can generate a planar region in space where the intensity of the light signals from each light source is the same. In this particular embodiment, this occur at an angle equal to 0° as illustrated in FIG. 1B, where the radiation pattern of the two light sources intersect at angle of 0°, no matter how close or far the on-board light detector is from the light sources.

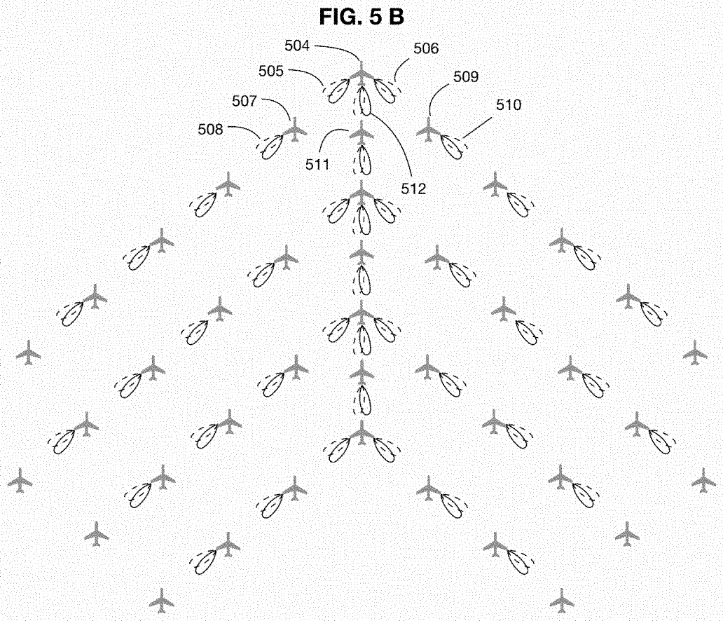

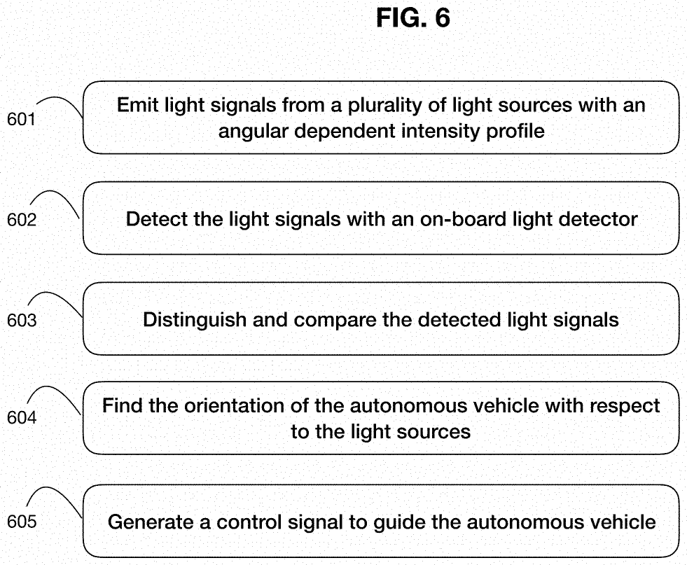

In another embodiment, a ground station 104 with two pairs of light sources comprised by light sources 105, 106, 107 and 108 generate two planar regions 110 and 111 in space of equal light intensity. This is illustrated in FIG. 10. The intersection of these two planes define a straight path 113 in space that can be used as a reference by the autonomous vehicle 112 to determine its position and orientation in relation to the light sources. Furthermore, if an autonomous vehicles follows that path in space, it can move precisely in straight line 111 from its location towards the light sources.

To determine the orientation and position of the autonomous vehicle with respect to the light sources and with respect to the straight path define by light sources, the light signals are detected with an on-board light detector and processed with an on-board processing logic. Each light signal is unique so that they can be distinguished. Moreover, using an a priori knowledge of the position of the light sources and the unique signal each one emits, the position and orientation of the autonomous vehicle with respect to the light sources can be known. FIG. 2A shows an exemplary situation where an autonomous vehicle is exactly lined up with respect to a pair of light sources with radiation patterns 201 and 202 respectively (light sources not shown, only their radiation pattern). In this case, the intensity of the light signals 205 and 206 detected by the on-board light detector are exactly the same, as illustrated in FIG. 2B. In one embodiment, this means that the autonomous vehicle 204 can maintain its current course to navigate from its current position towards the light sources mounted on a ground station, for example, by following the guide path 203 defined by the light sources.

FIG. 2C shows another exemplary situation where an autonomous vehicle is off-centered to the left with an angle 207 different to 0° with respect to two light sources with radiation patterns 201 and 202 respectively. In this case, the intensity of the light signals 205 and 206 detected by the on-board light detector are different, as illustrated in FIG. 2D. The detected light signal 205 corresponding to radiation pattern 201 is larger than the detected light signal 206 corresponding to radiation pattern 202. In one embodiment, this means that the autonomous vehicle 204 must correct its course to equalize the intensity of both detected light signals 205 and 206 to get lined up and be able to follow the guide path 203 defined by the light sources towards a ground station, for example. FIGS. 2E-2F show a similar exemplary situation but being off-centered to the right.

FIG. 3A shows another exemplary situation where an autonomous vehicle is exactly lined up with respect to a pair of light sources with radiation patterns 301 and 302 respectively (light sources not shown, only their radiation pattern). In this case, the intensity of the light signals 305 and 306 detected by the on-board light detector are exactly the same, as illustrated in FIG. 3B. In one embodiment, this means that the autonomous vehicle 303 can maintain its current course to navigate from its current position towards the light sources mounted on a ground station, for example, by following the guide path 304 defined by the light sources.

FIGS. 3C and 3E show another exemplary situation where an autonomous vehicle is off-centered vertically with an angle 307 different to 0° with respect to a pair of light sources with radiation pattern 301 and 302 respectively (light sources not shown, only their radiation pattern). In this case, the intensity of the light signals 305 and 306 detected by the on-board light detector are different, as illustrated in FIG. 3D and FIG. 3F. In some embodiments, this means that the autonomous vehicle 303 must correct its course to equalize the intensity of both detected light signals 305 and 306 to get lined up and be able to follow the guide path 304 defined by the light sources towards a ground station, for example. FIGS. 3E-3F show a similar exemplary situation but being off-centered to the right.

FIG. 4 shows an embodiment wherein multiple pairs of light sources 401 (light sources not shown, only their radiation pattern) are used to guide multiple autonomous vehicles simultaneously. The light signals emitted from each pair of light sources provide guide paths 403 that can be used to guide the vehicles in straight line from their current position towards a ground station, for example. In some embodiments, a transition from satellite-based navigation to light-based guidance allows collision-free precision guidance of multiple vehicles from a region 2 with a sparse vehicle density 404 to a region 1 with a high vehicle density 402 as they approach a ground station.

FIG. 5A shows another exemplary embodiment wherein the light signals 502 emitted from a pair of light sources mounted on a vehicle 501 provides a guide path that can be used to guide a subsequent vehicle 503 behind. Moreover, multiple vehicles can have each a pair of light sources hence guiding a plurality of vehicles in straight line during cruising, takeoff or landing maneuvers, for example. Each one of the vehicles has an on-board light detector to detect the light signals in accordance with the methods of the present disclosure.

FIG. 5B Shows another exemplary embodiment where a vehicle 504 with on-board light sources emits guiding light signals with radiation patterns 505, 506 and 512, allowing guidance of neighboring vehicles behind 507, 509 and 511. In such arrangement and in accordance to the method disclosed herein, a plurality of autonomous vehicles can be guided precisely following a fixed formation in maneuvers such as cruising, for example.

FIG. 6 Illustrates a block diagram that describes the steps to accomplish guidance of an autonomous vehicle using a plurality of light sources, in accordance with an embodiment of the present disclosure.

In some embodiments, the on board light detector has a lens to create an image of the light sources on the light detector.

In an exemplary embodiment, the light signals are any of the following: amplitude modulated sinusoidal carrier signals, CDMA codes, a data stream, an encrypted data stream, an amplitude modulated signal of any other periodic waveform or a spread spectrum signal.

In some embodiments, the light signals are detected via one or a combination of the following: demodulation, decryption, CDMA decoding, polarization multiplexing, wavelength division multiplexing.

In some exemplary embodiments, the orientation of the autonomous vehicles is determined by the on-board processing logic with an a-priori knowledge of the relative orientation between the light sources in the ground station and the unique light signal each light source emits. By comparing the relative strength between the detected signals, a control signal is generated to guide with precision the autonomous vehicles towards the ground station, for example.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A guidance system for autonomous vehicles comprising:
A plurality of light sources, each emitting a light signal with an angular dependent intensity profile.
A light detector, configured to detect the plurality of light signals emitted from each one of the light sources
Processing logic configured to receive a plurality of detected light signals generated by the light detector, the processing logic configured to:
Receive the detected light signals detected by the light detector while the emitted light signals are incident on the light detector
Distinguish each one of the detected light signals detected by the light detector
Compare the distinguished detected light signals
Use the distinguished detected light signals to encounter the orientation of the light detector relative to the light sources
Generate a control signal from the distinguished detected light signals
Use the control signal to provide navigation guidance to the autonomous vehicle

2. The system of claim 1, wherein each emitted light signal is unique.

3. The system of claim 1, wherein each light source is one or a plurality from the following list:
I. An LED
II. An array of LEDs
III. A laser source
IV. A flash lamp
V. An incandescent light bulb

4. The system of claim 1, wherein the angular dependent intensity profile of the light sources can be achieved by shaping the emitted light with one or a combination of items from the following list:
I. Lenses
II. Diffractive optical elements
III. Multimode optical fibers
IV. Fiber optic faceplates
V. Optical waveguides
VI. Optical diffusers

5. The system of claim 1, wherein the light signal emitted from each light source is one or a combination from the following list:
I. An amplitude modulated sinusoidal carrier signal.
II. CDMA codes
III. A data stream
IV. An encrypted data stream
V. An amplitude modulated signal of any other periodic waveform.
VI. A spread spectrum signal

6. The system of claim 1, wherein the detected light signals are distinguished based on one or a combination of items from the following list:
I. Demodulation
II. Decryption
III. CDMA decoding
IV. polarization
V. wavelength division multiplexing

7. The system of claim 1, wherein the light detector is one or a combination of items from the following list:
I. A photodiode
II. An avalanche photodiode
III. A photomultiplier tube
IV. A photodetector
V. A multi-pixel image sensor

8. The system of claim 1, wherein the navigation guidance is used in one or a combination of maneuvers from the following list:
I. takeoff
II. Landing
III. Approaching
IV. Cruising
V. Transition from satellite-based navigation to light-based
navigation or vice versa, or both
VI. Augmentation of a satellite-based navigation
VII. Guidance of a swarm of autonomous vehicles

9. The system of claim 1, wherein the autonomous vehicles are any or a combination of items from the following list:
I. Aerial vehicles
II. Maritime vehicles
III. Ground vehicles
IV. Space vehicles
V. Submarines

10. The system of claim 1, wherein the light sources are mounted in any of the items from the following list:
I. A ground station
A terrestrial vehicle
III. A maritime vessel
IV. An aerial vehicle

11. The system of claim 1, wherein the light detector and processing logic are mounted in an autonomous vehicle

12. The system of claim 1, wherein a pair of light sources define a plane in space in which the power of the light signals emitted by the two light sources is equal.

13. The system of claim 12, wherein the plane in space provides orientation to the autonomous vehicle relative to the light sources.

14. The system of claim 1 further comprising: A steering mechanism to reconfigure the orientation of the light sources to provide a different guidance path.

15. The system of claim 1 further comprising: An inertial measurement unit (IMU) configured to increase the orientation accuracy of the autonomous vehicle relative to the light sources.

16. The system of claim 1, wherein the control signal provides one or a combination of items from the following list:
I. Pitch angle control
II. Roll angle control
III. Yaw angle control
IV. Lateral position control
V. Vertical position control
VI. Axial position control

17. A method for providing guidance to autonomous vehicles comprising:
Emitting light signals from a plurality of light sources, wherein each light source emits a light signal with an angular dependent intensity profile.
Detecting the plurality of emitted light signals with a light detector
Processing the plurality of light signals detected by the light detector to distinguish each one of the detected light signals
Comparing the distinguished detected light signals
Using the distinguished detected light signals to encounter the orientation of the light detector relative to the light sources
Generating a control signal from the distinguished detected light signal
Using the control signal to provide navigation guidance to the autonomous vehicle

18. The method of claim 17, wherein the light signal emitted from each light source is one or a combination of the items from the following list:
I. an amplitude modulated sinusoidal carrier signal.
II. A CDMA codes
III. A data stream
IV. An encrypted data stream
V. An amplitude modulated signal of any other periodic waveform.
VI. A spread spectrum signal

19. The method of claim 17, wherein the detected light signals are distinguished based on one or a combination of items from the following list:
I. Demodulation
II. Decryption
III. CDMA decoding
IV. Polarization
V. wavelength division multiplexing

20. The method of claim 17, wherein the navigation guidance is used in one or a combination of maneuvers from the following list:
I. Takeoff
II. Landing
III. Approaching
IV. Cruising
VIII. Transition from satellite-based navigation to light-based navigation or vice versa, or both
IX. Augmentation of a satellite-based navigation
X. Guidance of a swarm of autonomous vehicles

21. The method of claim 17, wherein the autonomous vehicles are any or a combination of items from the following list:
I. Aerial vehicles
II. Maritime vehicles
III. Ground vehicles
IV. Space vehicles
V. Submarines

22. The method of claim 17 further comprising: Steering the orientation of the light sources to provide a different guidance path.

23. The method of claim 17, wherein the control signal provides one or a combination of items from the following list:
I. Pitch angle control
II. Roll angle control
III. Yaw angle control
IV. Lateral position control
V. Vertical position control
VI. Axial position control
